(19) United States
(12) Patent Application Publication
(10) Pub. No.: US 2025/0101624 A1
(43) Pub. Date: Mar. 27, 2025

(54) APPARATUSES AND METHODS FOR DISLODGING MATERIAL FROM AN ELECTRODE

(71) Applicant: ZINC8 ENERGY SOLUTIONS INC., Vancouver (CA)

(72) Inventors: Tristan SLOAN, Vancouver (CA); Hamid BANIS, Vancouver (CA); Jerry ZHAO, Vancouver (CA); Simon FAN, Vancouver (CA)

(21) Appl. No.: 18/730,511

(22) PCT Filed: Jan. 27, 2023
(86) PCT No.: PCT/CA2023/050115

§ 371 Date: Jul. 19, 2024

Related U.S. Application Data
(60) Provisional application No. 63/303,948, filed on Jan. 27, 2022.

(51) Int. Cl. C25C 7/08; B08B 5/02; C25C 1/16; C25C 7/02; C25D 17/10; C25D 21/08

(52) U.S. Cl. CPC C25C 7/08; B08B 5/02; C25C 7/02; C25C 1/16; C25D 17/10; C25D 21/08

(57) ABSTRACT

Provided is a method for dislodging material from a surface of an electrode. The surface of the electrode is generally covered by a liquid electrolyte. The method comprises forcing a mass of gas onto a surface of the liquid electrolyte, thereby causing movement of the liquid electrolyte in a direction generally parallel to a plane of the surface of the electrode. The movement of the liquid electrolyte imparts a force to the material on the surface of the electrode thereby causing the material to dislodge. Also provided is an apparatus for dislodging material from a surface of an electrode. The apparatus comprises an electrode generally covered by a liquid electrolyte, a body containing the liquid electrolyte with at least one liquid inlet, at least one liquid outlet, and at least one gas inlet. The at least one gas inlet is positioned such that the at least one gas inlet and the at least one liquid outlet are separated by a volume in which a portion of some of the liquid electrolyte at or near the surface of the electrode is present, and a pressurized gas source operably connected to the at least one gas inlet.

### TECHNICAL FIELD

This invention relates to the field of electrodes and fluid dynamics and more particularly to the application of fluid dynamics for cleaning electrodes.

### BACKGROUND

Electrochemical apparatuses using electrodes often experience a buildup of material on one of more of the electrodes during normal operation of the apparatus. Such buildups can result in a loss of function and/or efficiency of the apparatus.

JP 2016090241 teaches to provide an electrode contamination removal structure that can sufficiently remove contamination of a surface of an electrode without using an electronic circuit. An electrode contamination removal structure comprises: a first electrode; a second electrode opposing the first electrode; a coupling bar that is rotatably provided between the first electrode and the second electrode; a first contamination removal member that comes into contact with the first electrode and is provided at one end of the coupling bar so as to remove contamination at a prescribed part of the first electrode when the coupling bar rotates; a second contamination removal member that comes into contact with the second electrode and is provided at the other end of the coupling bar so as to remove contamination at a prescribed part of the second electrode when the coupling bar rotates; an electrode reception container in which the first and second electrode and, and the coupling bar are received; and a weight that is provided in the coupling bar for rotating the coupling bar due to an impact when the electrode reception container falls to a liquid.

KR 101399318 relates to an electrode washing device of an eddy induction type and, more specifically, to an electrode washing device for preventing oxidation of an electrode by washing the electrode, whose the surface is changed to a strong alkali state, quickly by an electrolysis process such as tritium concentrated by an electrolytic concentration method, etc. According to KR 101399318, the electrode washing device induces space for washing an electrode to generate an eddy, so the ability to wash the electrode can be improved. Moreover, the present invention has an effect for manufacturing, using, and maintaining the device easily by simplifying the structure of the device while performing a washing process of an electrode smoothly. Therefore, the reliability and competitiveness of the device can be improved in a similar or related field, such as the washing field of an electrode used in electrolysis, the various fields using the electrolysis, the analysis field of a sample through the electrolysis, etc.

### SUMMARY

This invention is based, at least in part, on the elucidation of various aspects of moving electrolyte across the surface of an electrode in order to dislodge material from the surface of the electrode.

In illustrative embodiments of the present invention, there is provided a method for dislodging material from a surface of an electrode, the surface of the electrode being generally covered by a liquid electrolyte, the method comprising: forcing a mass of gas onto a surface of the liquid electrolyte, thereby causing movement of the liquid electrolyte, the movement of the liquid electrolyte being in a direction generally parallel to a plane of the surface of the electrode, the movement of the liquid electrolyte imparting force to the material on the surface of the electrode thereby causing the material to dislodge from the surface of the electrode.

In illustrative embodiments of the present invention, there is provided a method described herein wherein the movement of the liquid electrolyte is at a superficial velocity of at least about 0.1 m/s.

In illustrative embodiments of the present invention, there is provided a method described herein wherein the movement of the liquid electrolyte is at a superficial velocity of from about 0.1 m/s to about 0.2 m/s.

In illustrative embodiments of the present invention, there is provided a method described herein wherein the mass of gas is distributed evenly over the surface of the liquid electrolyte.

In illustrative embodiments of the present invention, there is provided a method described herein further comprising forcing a second mass of gas onto the surface of the liquid electrolyte, thereby causing a second movement of the liquid electrolyte, the second movement of the liquid electrolyte being in a direction generally parallel to the plane of the surface of the electrode, the second movement of the liquid electrolyte imparting force to the material on the surface of the electrode thereby causing the material to dislodge from the surface of the electrode.

In illustrative embodiments of the present invention, there is provided a method described herein wherein the second movement of the liquid electrolyte has a second superficial velocity of at least about 0.1 m/s.

In illustrative embodiments of the present invention, there is provided a method described herein wherein the second movement of the liquid electrolyte has a second superficial velocity of about 0.1 m/s.

In illustrative embodiments of the present invention, there is provided a method described herein wherein the mass of gas is forced onto the surface of the liquid electrolyte by applying pressurized gas to a space immediately adjacent the surface of the liquid electrolyte through at least one gas inlet in a body containing the liquid electrolyte.

In illustrative embodiments of the present invention, there is provided a method described herein wherein the mass of gas has an initial pressure of from about 10 psi to about 100 psi prior to being added to the space.

In illustrative embodiments of the present invention, there is provided a method described herein wherein the mass of gas has an initial pressure of from about 30 psi to about 50 psi prior to being added to the space.

In illustrative embodiments of the present invention, there is provided a method described herein wherein the mass of gas has an initial pressure of about 50 psi prior to being added to the space.

In illustrative embodiments of the present invention, there is provided a method for dislodging material from a surface of an electrode, the surface of the electrode generally covered by a liquid electrolyte, the method comprising: forcing a mass of gas through at least one gas inlet of a body containing the liquid electrolyte onto a surface of the liquid electrolyte, thereby causing movement of the liquid electrolyte, the mass of gas exiting the at least one gas inlet at a pressure in the range of from about 100 psi to about 10 psi, the movement of the liquid electrolyte being in a direction generally parallel to a plane of the surface of the electrode and at a superficial velocity of at least about 0.1 m/s, the movement of the liquid electrolyte imparting force to the material on the surface of the electrode thereby causing the material to dislodge from the surface of the electrode.

In illustrative embodiments of the present invention, there is provided a method described herein wherein the superficial velocity is about 0.1 m/s.

In illustrative embodiments of the present invention, there is provided a method described herein further comprising forcing a second mass of gas through the at least one gas inlet of the body containing the liquid electrolyte onto the surface of the liquid electrolyte, thereby causing a second movement of the liquid electrolyte, the second mass of gas exiting the at least one gas inlet at a pressure in the range of from about 100 psi to about 10 psi, the second movement of the liquid electrolyte being in a direction generally parallel to the plane of the surface of the electrode and at a second superficial velocity of at least 0.1 m/s, the second movement of the liquid electrolyte imparting force to the material on the surface of the electrode thereby causing the material to dislodge from the surface of the electrode.

In illustrative embodiments of the present invention, there is provided a method described herein with the second superficial velocity is from about 0.1 m/s to about 0.2 m/s.

In illustrative embodiments of the present invention, there is provided a method described herein wherein the at least one gas inlet is positioned above the surface of the liquid electrolyte to which the mass of gas is applied.

In illustrative embodiments of the present invention, there is provided a method described herein wherein the at least one gas inlet is positioned so that the gas enters the body in a direction that is generally perpendicular to the surface of the liquid electrolyte to which the mass of gas is applied.

In illustrative embodiments of the present invention, there is provided a method described herein wherein the material was deposited on the electrode by electrochemical deposition.

In illustrative embodiments of the present invention, there is provided a method described herein wherein the material is a metal.

In illustrative embodiments of the present invention, there is provided a method described herein wherein the material is zinc.

In illustrative embodiments of the present invention, there is provided a method described herein wherein the electrode is magnesium.

In illustrative embodiments of the present invention, there is provided a method described herein wherein the liquid electrolyte is KOH In illustrative embodiments of the present invention, there is provided a method described herein wherein the gas is air.

In illustrative embodiments of the present invention, there is provided an apparatus for dislodging material from a surface of an electrode, the apparatus comprising: (a) an electrode generally covered by a liquid electrolyte; (b) a body containing the liquid electrolyte, the body having at least one liquid inlet, at least one liquid outlet, and at least one gas inlet, the at least one gas inlet being positioned such that the at least one gas inlet and the at least one liquid outlet are separated by a volume in which volume a portion of some of the liquid electrolyte is present and some of that portion of liquid electrolyte is at or near the surface of the electrode; and (c) a pressurized gas source operably connected to the at least one gas inlet; wherein the liquid electrolyte may enter the body via the at least one liquid inlet and may exit the body via the at least one liquid outlet and a pressurized gas from the pressurized gas source may enter the body via the at least one gas inlet.

In illustrative embodiments of the present invention, there is provided an described herein wherein the electrode has a longitudinal plane that is generally parallel to a plane of the surface of the liquid electrolyte when the liquid electrolyte is contained in the body.

In illustrative embodiments of the present invention, there is provided an described herein wherein the at least one liquid inlet is positioned such that liquid electrolyte from the at least one liquid inlet must pass the longitudinal plane of the electrode to exit the body via the at least one liquid outlet.

In illustrative embodiments of the present invention, there is provided an described herein wherein the at least one gas inlet comprises baffles for distributing the pressurized gas as it enters the body.

In illustrative embodiments of the present invention, there is provided an described herein wherein the pressurized gas source has a pressure in the range of from about 10 psi to about 100 psi.

In illustrative embodiments of the present invention, there is provided an described herein wherein the pressurized gas source has a pressure in the range of from about 30 psi to about 50 psi.

In illustrative embodiments of the present invention, there is provided an described herein wherein the pressurized gas source has a pressure of about 50 psi.

In illustrative embodiments of the present invention, there is provided an described herein wherein the pressurized gas is operably linked to the at least one liquid inlet such that as gas enters the body via the at least one gas inlet, thereby forcing some liquid electrolyte to exit the body via the at least one liquid outlet, the at least one liquid inlet is then activated to maintain a generally constant volume of liquid electrolyte in the body.

In illustrative embodiments of the present invention, there is provided an described herein wherein said dislodged material may exit the body via the at least one liquid outlet.

In illustrative embodiments of the present invention, there is provided an described herein wherein the at least one gas inlet is two gas inlets.

In illustrative embodiments of the present invention, there is provided an described herein wherein the at least one gas inlet is one gas inlet.

In illustrative embodiments of the present invention, there is provided an described herein wherein the at least one liquid inlet is two liquid inlets.

In illustrative embodiments of the present invention, there is provided an described herein wherein the at least one liquid inlet is one liquid inlet.

In illustrative embodiments of the present invention, there is provided an described herein wherein the at least one liquid outlet is two liquid outlets.

In illustrative embodiments of the present invention, there is provided an described herein wherein the at least one liquid outlet is one liquid outlet.

In illustrative embodiments of the present invention, there is provided an described herein wherein the material was deposited on the electrode by electrochemical deposition.

In illustrative embodiments of the present invention, there is provided an described herein wherein the material is a metal.

In illustrative embodiments of the present invention, there is provided an described herein wherein the material is zinc.

In illustrative embodiments of the present invention, there is provided an described herein wherein the electrode is magnesium.

In illustrative embodiments of the present invention, there is provided an described herein wherein the liquid electrolyte is KOH In illustrative embodiments of the present invention, there is provided an described herein wherein the gas is air.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is an illustration of fully developed flow profile between parallel plates.

FIG. 2 is a an illustration showing the effect of increasing gap size on velocity profile and maximum velocity required to dislodge equivalent amounts of material from an electrode.

FIG. 3 is an illustration showing the effect of relative gap size on flux.

FIG. 4 is an illustration showing a cross-sectional side view of an embodiment of an apparatus according to the present invention.

FIG. 5 is an illustration showing an alternative cross-sectional side view of an apparatus according to the present invention.

### DETAILED DESCRIPTION

As used herein, the phrase “generally covered” means that strict adherence to the term “covered” is not required. For example, “generally covered” refers to a covering, which may be completely covered or mostly completely covered, but not less than 50% completely covered. In some embodiments, “generally covered” refers to not less than 60% completely covered. In other embodiments, “generally covered” refers to not less than 70% completely covered. In other embodiments, “generally covered” refers to not less than 80% completely covered. In other embodiments, “generally covered” refers to not less than 90% completely covered. In other embodiments, “generally covered” refers to not less than 95% completely covered. In other embodiments, “generally covered” refers to not less than 96% completely covered. In other embodiments, “generally covered” refers to not less than 97% completely covered. In other embodiments, “generally covered” refers to not less than 98% completely covered. In other embodiments, “generally covered” refers to not less than 99% completely covered. In other embodiments, “generally covered” refers to not less than 99.5% completely covered. In other embodiments, “generally covered” refers to not less than 99.9% completely covered. In other embodiments, “generally covered” refers to in a range of from 99% to 100% completely covered.

As used herein, the phrase “generally perpendicular” means that strict adherence to the term “perpendicular” is not required. For example, “generally perpendicular” refers to two entities, which may be completely perpendicular or close to perpendicular, but not less than 10% variation from completely perpendicular. In some embodiments, “generally perpendicular” refers to not less than 5% variation from completely perpendicular. In some embodiments, “generally perpendicular” refers to not less than 4% variation from completely perpendicular. In some embodiments, “generally perpendicular” refers to not less than 3% variation from completely perpendicular. In other embodiments, “generally perpendicular” refers to not less than 2% variation from completely perpendicular. In other embodiments, “generally perpendicular” refers to not less than 1% variation from completely perpendicular. In other embodiments, “generally perpendicular” refers to not less than 0.5% variation from completely perpendicular. In other embodiments, “generally perpendicular” refers to not less than 0.1% variation from completely perpendicular. In other embodiments, “generally perpendicular” refers to a variation in the range of from 1% to 0% from completely perpendicular.

As used herein, the phrase “generally parallel” means that strict adherence to the term “parallel” is not required. For example, “generally parallel” refers to two entities, which may be completely parallel or close to parallel, but not less than 10% variation from completely parallel. In some embodiments, “generally parallel” refers to not less than 5% variation from completely parallel. In some embodiments, “generally parallel” refers to not less than 4% variation from completely parallel. In some embodiments, “generally parallel” refers to not less than 3% variation from completely parallel. In other embodiments, “generally parallel” refers to not less than 2% variation from completely parallel. In other embodiments, “generally parallel” refers to not less than 1% variation from completely parallel. In other embodiments, “generally parallel” refers to not less than 0.5% variation from completely parallel. In other embodiments, “generally parallel” refers to not less than 0.1% variation from completely parallel. In other embodiments, “generally parallel” refers to a variation in the range of from 1% to 0% from completely parallel.

As used herein, the term “generally constant” means that strict adherence to the term “constant” is not required. For example, “generally constant” refers to an volume that is relatively the same as time progresses from a starting volume to a current volume, but that the current volume has less than 10% variation from the starting volume. In some embodiments, “generally constant” refers to the current volume having less than 5% variation from the starting volume. In some embodiments, “generally constant” refers to the current volume having less than 4% variation from the starting volume. In some embodiments, “generally constant” refers to the current volume having less than 3% variation from the starting volume. In some embodiments, “generally constant” refers to the current volume having less than 2% variation from the starting volume. In some embodiments, “generally constant” refers to the current volume having less than 1% variation from the starting volume. In some embodiments, “generally constant” refers to the current volume having less than 0.5% variation from the starting volume. In some embodiments, “generally constant” refers to the current volume having less than 0.1% variation from the starting volume. In other embodiments, “generally constant” refers to a variation between starting volume and current volume in the range of from 1% to 0%.

As used herein the term “about” means that precise adherence to the exact numerical value following the term “about” is not absolutely required or essential and that some minor deviation from the exact value is permissible. In some embodiments, a deviation of ±10% is acceptable. In some embodiments, a deviation of ±5% is acceptable. In other embodiments, a deviation of ±4% is acceptable. In other embodiments, a deviation of ±3% is acceptable. In other embodiments, a deviation of ±2% is acceptable. In other embodiments, a deviation of ±1% is acceptable. In other embodiments, a deviation of ±0% is acceptable.

As used herein, the term “superficial velocity” refers to the velocity of a portion of the liquid electrolyte, which portion of the liquid electrolyte is at or very close to the location of the material on the surface of the electrode. The velocity of this portion of the liquid electrolyte is important in terms of being able to dislodge the material deposited on the electrode. The superficial velocity may be the same as or different from the average velocity of the electrolyte as a whole. Often, the superficial velocity is different from the average velocity of the electrolyte as a whole and this may be in part due to a number of factors, including but not limited to the shape of the body containing the electrolyte, and the manner with which the mass of gas is applied to the electrolyte.

In embodiments of the present invention, there is provided a method for dislodging material from a surface of an electrode. The surface of the electrode is generally covered by a liquid electrolyte. The method comprises forcing a mass of gas onto a surface of the liquid electrolyte. This force causes movement of the liquid electrolyte. Often the movement of the liquid electrolyte is in a direction that is generally perpendicular to a plane of a top surface of the liquid electrolyte. Often the movement of the liquid electrolyte is in a direction that is parallel to a plane of the surface of the electrode. In some embodiments, the movement of the liquid electrolyte is both in a direction that is generally perpendicular to the plane of the top surface of the liquid electrolyte and in a direction that is parallel to the plane of the surface of the electrode. The movement of the liquid electrolyte imparts a force to the material on the surface of the electrode thereby causing the material to dislodge from the surface of the electrode. This method may be performed once, twice or more times until enough material is sufficiently dislodged from the electrode.

In some embodiments, the movement of the liquid electrolyte is at a superficial velocity of at least about 0.1 m/s. In some preferred embodiments, the movement of the liquid electrolyte is at a superficial velocity of from about 0.1 m/s to about 0.2 m/s. In some other preferred embodiments, the movement of the liquid electrolyte is at a superficial velocity of about 0.1 m/s.

It is preferred that the mass of gas is distributed evenly over the surface of the liquid electrolyte. An exact even distribution of the gas is not required, but the more even the distribution of gas across the entire surface of the electrolyte, the more even the force imparted to the electrolyte is, resulting in a more consistent superficial velocity of the electrolyte.

In particularly preferred embodiments, there is provided a method for dislodging material from a surface of an electrode, the surface of the electrode generally covered by a liquid electrolyte, the method comprising: forcing a mass of gas through at least one gas inlet of a body containing the liquid electrolyte onto a surface of the liquid electrolyte, thereby causing movement of the liquid electrolyte, the mass of gas exiting the at least one gas inlet at a pressure in the range of from about 100 psi to about 10 psi, the movement of the liquid electrolyte being in a direction generally parallel to the plane of the surface of the electrode and at a superficial velocity of at least about 0.1 m/s, the movement of the liquid electrolyte imparting force to the material on the surface of the electrode thereby causing the material to dislodge from the surface of the electrode. This method may be performed once, two or more times until the desired amount of material has been dislodged from the electrode.

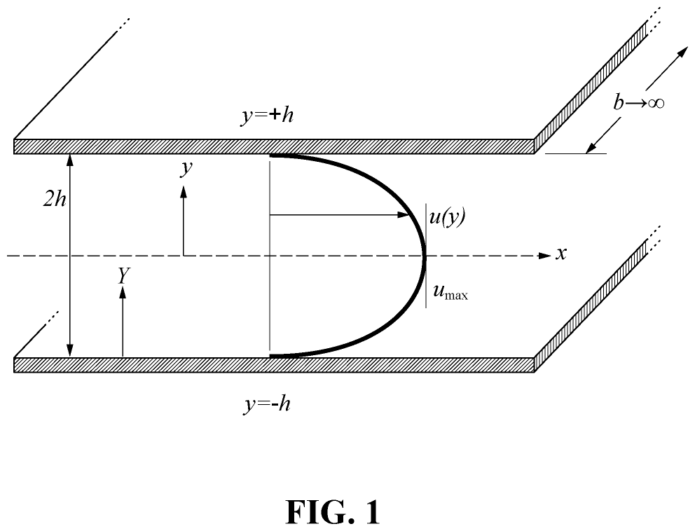

Theory for flow between parallel plates is understood to a person of skill in the art. For fully developed laminar flow between parallel plates, (See FIG. 1), the fluid velocity near the surface can be estimated from the following (Chapter 4 of “Fluid Mechanics” (Mcgraw-Hill Series in Mechanical Engineering) (7th Edition) by Frank M. White, 2010):

$$u = - \frac{dp}{dx} \frac{{h}^{2}}{2 μ} ( 1 - \frac{{y}^{2}}{{h}^{2}} )$$

From this expression it can be shown that the average fluid velocity through the parallel plates can be related to the maximum velocity as

$${V}_{a v e r a g e} = \frac{Q}{2 b h} = \frac{2}{3} {u}_{max}$$

If the flow rate required to dislodge material from an electrode is determined experimentally for a certain gap size, then the maximum velocity of the fluid may be estimated.

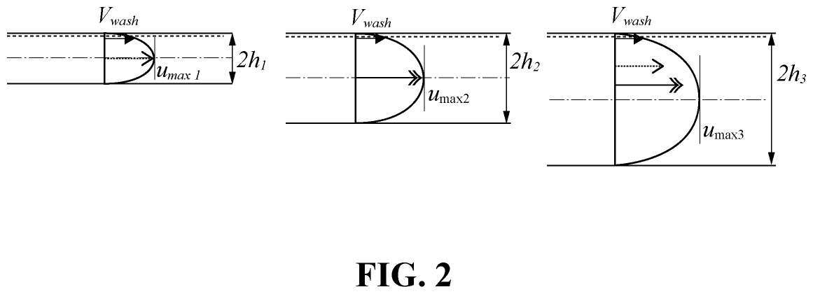

FIG. 2 shows qualitative effects of increasing the gap size. If V_{wash} is the fluid velocity required to dislodge material at the surface of the material growth, and it is independent of the gap size, it can be seen that the maximum fluid velocity will need to increase as gap size increases. Assuming the same washing velocity at the surface of the material is required to dislodge the material, then the following relationship may apply:

$${u}_{max} ∝ gap size$$

From this it can be deduced that

$${u}_{max 2} \approx \frac{{h}_{2}}{{h}_{1}} {u}_{max 1}$$

This can be confirmed through theory. From the equation for the velocity profile above, μₘₐₓ occurs when y=0 and, therefore, can be expressed as

$${u}_{max} = - \frac{d p}{d x} \frac{{h}^{2}}{2 μ}$$

$$Therefore ,$$

$$u = {u}_{max} ( 1 - \frac{{y}^{2}}{{h}^{2}} ) = \frac{3}{4} \frac{Q}{b h} ( 1 - \frac{{y}^{2}}{{h}^{2}} )$$

Where y is from the center between the parallel plates (see FIG. 1).

When considering washing material from an electrode surface, if two gap sizes are considered and the velocity at the material surface required to dislodge the material is the same, the above expression can be re-written as

$${u}_{w a s h} = {u}_{max 1} ( 1 - \frac{{y}_{1}^{2}}{{h}_{1}^{2}} ) = {u}_{max 2} ( 1 - \frac{{y}_{2}^{2}}{{h}_{2}^{2}} )$$

$${u}_{max 1} = {u}_{max 2} \frac{( 1 - \frac{{y}_{2}^{2}}{{h}_{2}^{2}} )}{( 1 - \frac{{y}_{1}^{2}}{{h}_{1}^{2}} )}$$

When y≈h then

$${u}_{max 1} \approx {u}_{max 2} \frac{{h}_{1}}{{h}_{2}}$$

To estimate the required flow rate for various gap sizes, knowing the minimum flow rate for one particular gap size. If

$$\frac{{Q}_{1}}{2 b {h}_{1}} = \frac{2}{3} {u}_{max 1}$$

$$Then ,$$

$${Q}_{2} = 2 b {h}_{2} \times \frac{2}{3} {u}_{max 2} = 2 b {h}_{2} \times \frac{2}{3} \frac{{h}_{2}}{{h}_{1}} {u}_{max 1} = \frac{4 b {h}_{2}^{2} {u}_{max 1}}{3 {h}_{1}}$$

$$Therefore ,$$

$${Q}_{2} = {Q}_{1} \frac{{h}_{2}^{2}}{{h}_{1}^{2}}$$

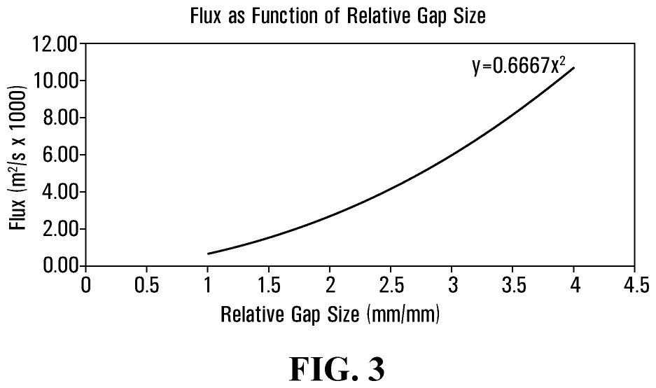

FIG. 3 illustrates that as gap size increases the required flow rate will increase to the second power (for case where u_max=1 m/s when h=1 mm). Since pumping power increases to the third power (Affinity Laws) of flow rate, it is clear that parasitic load due to pumping losses can quickly grow.

The effects of charge density should also be considered, in light of this theory. Depending on the porosity of the material grown it could be assumed that as the thickness of the material layer increases the higher the fluid velocity at the surface becomes, when holding everything else constant, as

$$u = {u}_{max} ( 1 - \frac{{y}^{2}}{{h}^{2}} )$$

If δ is the thickness of the material layer, then

$$y = h - δ$$

$$u = {u}_{max} ( 1 - \frac{{( h - δ )}^{2}}{{h}^{2}} )$$

If the material layer is x times larger than the above, then

$${u}_{2} = {u}_{max} ( 1 - \frac{{( h - x δ )}^{2}}{{h}^{2}} )$$

$${u}_{2} = {u}_{max} ( \frac{{h}^{2} - ( {h}^{2} - 2 x h δ + {x}^{2} {δ}^{2} )}{{h}^{2}} )$$

$${u}_{2} = {u}_{max} ( \frac{2 x h δ - {x}^{2} {δ}^{2}}{{h}^{2}} ) = x δ {u}_{max} ( \frac{2 h - x δ}{{h}^{2}} )$$

If δ<<h, and x<2 then

$${u}_{2} \approx \frac{2 x δ {u}_{max}}{h}$$

This implies that as the material layer increases, the velocity at the surface of the material increases nearly proportionally. If the same washing velocity is required to dislodge material, then it may be that the flow rate would be able to be reduced proportionally as well.

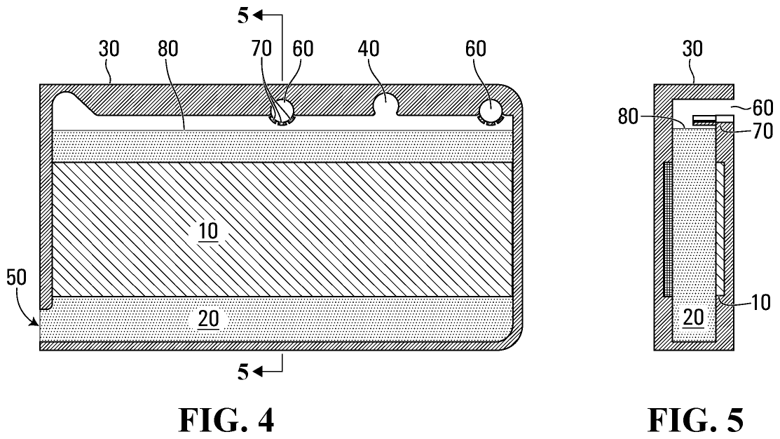

Referring to FIG. 4, in some embodiments of the present invention, there is provided an apparatus for dislodging material from a surface of an electrode 10. The apparatus comprises an electrode 10 generally covered by a liquid electrolyte 20, and a body 30 containing the liquid electrolyte 20. The body 30 has at least one liquid inlet 40, at least one liquid outlet 50, and at least one gas inlet 60. The at least one gas inlet 60 is positioned such that the at least one gas inlet 60 and the at least one liquid outlet 50 are separated by a volume. The volume that separates the at least one gas inlet 60 and the at least one liquid outlet 50 is a volume in which a portion of some of the liquid electrolyte 20 is present and some of that portion of liquid electrolyte 20 is at or near the surface of the electrode. The apparatus also comprises a pressurized gas source operably connected to the at least one gas inlet 60.

The liquid electrolyte 20 may enter the body 30 via the at least one liquid inlet 40 and may exit the body via the at least one liquid outlet 50. A pressurized gas from the pressurized gas source may enter the body 30 via the at least one gas inlet 60.

The electrode 10 may be made from any substance that is suitable for use as an electrode. Suitable substances are substances that are generally stable in electrolyte 20. Suitable substances include, but are not limited to, metals, stainless steel, nickel, iron, titanium, gold, silver, indium, lead, chromium, niobium, zirconium, tantalum, tungsten, combinations thereof as well as an alloy of those metals with any other metals and an alloy of those metals with another of those metals. In preferred embodiments, the electrode 10 is magnesium. The electrode 10 may be a cathode or an anode. The electrode 10 also has a longitudinal plane. The longitudinal plane of the electrode 10 is generally parallel to a plane of the top surface of the liquid electrolyte 20 when the liquid electrolyte 20 is contained in the body 30. The surface of the electrode 10 that is exposed to the electrolyte 20 has a plane. The plane of the surface of the electrode 10 is often perpendicular to the longitudinal plane of the electrode 10. FIG. 4 shows a line 80, which line 80 is a notional top of the liquid electrolyte 20. FIG. 4 also shows one particular arrangement for mounting the electrode 10 in the body 30.

During normal operation of an electrochemical apparatus, material will be deposited onto the electrode 10 via electrochemical deposition. The material deposited on the surface of the electrode 10 is often a metal, aluminum, iron, lithium, beryllium, calcium, magnesium, sodium, titanium, zinc, and combinations thereof. The material deposited on the surface of the electrode 10 is often zinc.

The liquid electrolyte 20 generally surrounds the electrode 10 and is contained within the body 30. The liquid electrolyte 20 is required for normal function of the electrochemical apparatus. It is desirable that a level of liquid electrolyte 20 in the body 30 does not drop below a level where the electrode 10 or a portion of the electrode 10 that is normally covered by liquid electrolyte 20 is no longer covered by the liquid electrolyte 20. Many liquid electrolytes 20 are known to a person of skill in the art and liquid electrolytes 20 are often aqueous ionic solutions, sodium hydroxide (NaOH), lithium hydroxide (LiOH), potassium hydroxide (KOH) and/or such solutions with dissolved components, such as zincate. Often the liquid electrolyte 20 is KOH and/or KOH with dissolved zincate.

The body 30 contains the liquid electrolyte 20 within the body 30 and the body 30 also supports the electrode 10 and maintains the location of the electrode 10 with respect to the remainder of the apparatus. These two functions of the body 30 result in the electrode being supported in a location that is generally surrounded by liquid electrolyte 20. The body 30 may be a single unit or may be two or more units connected together so that it performs these functions. Once example of a two unit body 30 is wherein each unit supports a single electrode 10 and when the two units are connected together into a single body 30, the two electrodes 10 are spaced apart as desired. The two or more units may be the same or may be different. In some two unit body 30 embodiments, the difference between the two units is that one unit comprises the holes for the inlets and outlets and the other does not. In other embodiments, the inlets and outlets are formed only by connecting the units together. In these latter embodiments, the holes are defined by a portion of each of the units connected together. The body 30 also defines the holes which are the at least one liquid inlets 40, the at least one liquid outlets 50 and the at least one gas inlets 60. The body 30 may be any shape that supports these functions and may be made from any suitable substance that supports these functions. Suitable substances for use in the body 30 are substances which are not electrically conductive. Often, suitable substances for use in the body 30 are substances that are compatible with the electrolyte 20 and do not react with the electrolyte 20. Some non-limiting examples of suitable substances for use in the body 30 are acrylic, polypropylene, HDPE, noryl PPO, ABS, CPVC, PVC, Acetal and combinations thereof. In preferred embodiments, the body is shaped such that the liquid electrolyte 20 is biased generally towards the at least one liquid outlet 50. Such a shape may be a gentle slope on one side of the body wherein the higher point of the slope is further from the at least one liquid outlet 50 than the lower point of the slope. Such a slope not only biases the liquid electrolyte 20 towards the at least one liquid outlet 50, but also biases any loose material, such as material dislodged from the electrode 10, towards the at least one liquid outlet 50. In preferred embodiments, the body 30 supports two electrodes 10, a cathode and an anode, and the two electrodes 10 are supported such that there is a consistent distance between the electrodes 10 along their lengths. The surfaces of each electrode 10 that are facing each other are preferably generally parallel and the longitudinal planes of each electrode 10 are preferably the same plane.

The at least one liquid inlet 40 is defined by the body 30 and is often positioned on the body 30 such that liquid electrolyte 20 entering the body 30 from the at least one liquid inlet 40 must pass the longitudinal plane of the electrode 10 to exit the body 30 via the at least one liquid outlet 50. In some embodiments, the at least one liquid inlet 40 is two liquid inlets 40. In preferred embodiments, the at least one liquid inlet 40 is one liquid inlet 40.

The at least one liquid outlet 50 is defined by the body 30 and is positioned on the body 30 such that liquid electrolyte 20 entering the body 30 from the at least one liquid inlet 40 must pass the longitudinal plane of the electrode 10 to exit the body 30 via the at least one liquid outlet 50. The at least one liquid outlet 50 functions not only to permit removal of liquid electrolyte 20 from the body 30, but also to permit removal of material dislodged from the electrode 10 as well as any other undesired material (such as material already dislodged from the electrode 10) in the liquid electrolyte 20 to be removed from the body 30. In this regard it is often preferable that the at least one liquid outlet 50 is sized slightly larger than the at least one liquid inlet 40. In some embodiments, liquid outlet 50 is positioned so that liquid electrolyte 20 can only exit the body 30 via liquid outlet 50 if additional fluid and/or liquid electrolyte 20 is added to the body 30 or the electrolyte 20 is moved towards the liquid outlet 50 via some force applied to the electrolyte 20. In some other embodiments, liquid outlet 50 comprises a valve operable to prevent and permit liquid electrolyte 20 exiting the body 30 via liquid outlet 50. In some embodiments, the at least one liquid outlet 50 is two liquid outlets 50. In some preferred embodiments, the at least one liquid outlet 50 is one liquid outlet 50.

The at least one gas inlet 60 is defined by the body 30 and is often positioned in the same general location as the liquid inlet 40. The at least one gas inlet 60 is positioned such that the at least one gas inlet 60 and the at least one liquid outlet 50 are separated by a volume. The volume that separates the at least one gas inlet 60 and the at least one liquid outlet 50 is a volume in which a portion of some of the liquid electrolyte 20 is present and some of that portion of liquid electrolyte 20 is at or near the surface of the electrode. Such a position is often on the body 30 such that pressurized gas entering the body 30 from the at least one gas inlet 60 would have to pass the longitudinal plane of the electrode 10 to exit the body 30 via the at least one liquid outlet 50, if the gas were to pass through the body 30 in that manner. However, pressurized gas is more typically dissipated through slow leakage from the body 30 rather than travelling through the liquid electrolyte 20. It is preferred that the pressurized gas does not come into contact with the electrode 10 directly. Often the body 30 defines baffles 70 for distributing the pressurized gas as it enters the body 30. The baffles 70 help to provide a more even distribution of a mass of gas across the top surface of the liquid electrolyte 20, thereby providing a more even force to the whole of the liquid electrolyte 20. More even distribution of the mass of gas results in a more consistent superficial velocity of the liquid electrolyte 20 being achieved across the surface of electrode 10. In some embodiments, the at least one gas inlet 60 is one gas inlet 60. In some preferred embodiments, the at least one gas inlet 60 is two gas inlets 60.

The pressurized gas source may be any pressurized gas source known to a person of skill in the art. For example, and without limitation, the source may be a pressurized container and/or canister, a compressor, or a liquid pump (often centrifugal) to generate head upstream of a column of air in a pipe section, then a valve between the column of air and gas inlets 60. The gas may be pressurized to a pressure in the range of from about 10 psi to about 100 psi. The gas may be pressurized to a pressure in the range of from about 30 psi to about 50 psi. The gas may be pressurized to a pressure of about 50 psi. The pressurized gas is preferably a gas that does not react, or reacts minimally, with the liquid electrolyte 20. Suitable gases for use as the pressurized gas include, but are not limited to, air, nitrogen, inert gasses such as argon, etc. In some embodiments, the pressurized gas source is operably linked to the at least one liquid inlet 40 such that as gas enters the body 30 via the at least one gas inlet 60, thereby forcing some liquid electrolyte 20 to exit the body via the at least one liquid outlet 50, the at least one liquid inlet 40 activates to maintain a generally constant volume of liquid electrolyte 20 in the body 30.

In some embodiments, the at least one gas inlet 60 is operably linked to the at least one liquid inlet 40 such that as liquid electrolyte 20 exits the body 30 via the at least one liquid outlet 50, the at least one liquid inlet 40 activates to maintain a generally constant volume of liquid electrolyte 20 in the body 30. Alternatively, the at least one liquid outlet 50 may be operably linked to the at least one liquid inlet 40 such that as liquid electrolyte 20 enters the body 30, the at least one liquid outlet activates to maintain a generally constant volume of liquid electrolyte 20 in the body 30. A non-limiting example of such an operable linkage is use of a check valve between a pump and the liquid inlet 40 to prevent flow back down the liquid inlet. Another non-limiting example of such operable linkage is the use of a device, such as a computer, that times the activation of a pump to introduce liquid electrolyte 20 to the body 30 at the at least one liquid inlet 40 and then activates the source of pressurized gas to introduce gas to the body 30 at the at least one gas inlet 60, then repeats the process after a predetermined amount of time. For example, and without limitation, the device may activate the pump for a duration of 5 seconds followed by activation of the pressurized gas source for 3 seconds followed by a waiting period of 40 seconds before repeating the process. Repeating the process is optional and need not necessarily be required.

In some embodiments of the present invention, there is provided a method for dislodging material from a surface of an electrode 10. The surface of the electrode 10 is generally covered by a liquid electrolyte 20. The method comprises forcing a mass of gas onto a surface of the liquid electrolyte 20, thereby causing movement of the liquid electrolyte 20. The movement of the liquid electrolyte 20 caused is in a direction that is generally parallel to the plane of the surface of the electrode 10. The movement of the liquid electrolyte 20 then imparts a force to the material on the surface of the electrode 10 thereby causing the material to dislodge from the surface of the electrode 10.

It is possible to determine the force that is required in order to achieve a particular superficial velocity of the liquid electrolyte 20 given a particular body 30. One method for determining such a force is provided by the equations provided above and measuring the distance between the electrode 10 and the other parallel surface, which may by the body 30 in the case of a single electrode apparatus and may be a second electrode 10 in the case of a two electrode apparatus.

In order that sufficient material is dislodged from the electrode 10, it is preferred that the movement of the liquid electrolyte 20 is at a superficial velocity of at least about 0.1 m/s. More preferably, the movement of the liquid electrolyte 20 is at a superficial velocity of from about 0.1 m/s to about 0.2 m/s. More preferably still, the movement of the liquid electrolyte 20 is at a superficial velocity of about 0.1 m/s. If the superficial velocity of the liquid electrolyte 20 is too low, then no material, or not enough material, will be dislodged from the electrode 10. If the superficial velocity is too high, depending on the nature and the construction of the body 30 and the remainder of the apparatus, it is possible that damage will be done to the body 30 and/or apparatus.

In some preferred embodiments, the mass of gas is distributed evenly over the surface of the liquid electrolyte 20. This can be encouraged with the use of baffles 70. More even distribution of the mass of gas results in a more consistent superficial velocity of the liquid electrolyte 20 being achieved across the length of the electrode 10.

It is also possible to repeat the forcing of a mass of gas onto the surface of the liquid electrolyte 20. This is particularly beneficial in cases where there are delicate parts in the apparatus and multiple dislodging events at lower superficial velocities are required to remove sufficient material from the electrode 10. As many repeats as is desired may be carried out. In some embodiments, a single repeat (i.e. two dislodging events) is sufficient. In some other embodiments two repeats are sufficient. In some embodiments three or more repeats are required.

The mass of gas is forced onto the surface of the liquid electrolyte 20 by applying pressurized gas to a space immediately adjacent to the surface of the liquid electrolyte 20. The mass of gas is introduced to the space through the at least one gas inlet 60 in the body 30 containing the liquid electrolyte 20. Pressurized gas is particularly suitable because it is desirable to fill the space as quickly and as evenly as possible, though absolute even distribution and maximum speed are not required. Even distribution, encouraged by baffles 70, and speedy space filling, encouraged by the gas being pressurized, are desirable in order to impart a more even and a sharper force to the surface of the liquid electrolyte 20. Such an even and sharp force moves the liquid electrolyte 20 more evenly and provides for a more consistent superficial velocity of the liquid electrolyte 20 across the surface of the electrode 10. Absolute even distribution is not required. The more even the distribution, the closer to perfect laminar flow of the electrolyte 20 will be achieved. While laminar flow of electrolyte 20 is preferred, non-laminar flow of electrolyte 20 is also suitable for removal of material from the electrode 10.

In some embodiments, the mass of gas has an initial pressure of from about 10 psi to about 100 psi prior to being added to the space. In some other embodiments, the mass of gas has an initial pressure of from about 30 psi to about 50 psi prior to being added to the space. In some other embodiments, the mass of gas has an initial pressure of about 50 psi prior to being added to the space.

In some preferred embodiments, there is provided a method for dislodging material from a surface of an electrode 10. The surface of the electrode 10 is generally covered by a liquid electrolyte 20. The method comprises forcing a mass of gas through at least one gas inlet 60 of a body 30 containing the liquid electrolyte 20 onto a surface of the liquid electrolyte 20, thereby causing movement of the liquid electrolyte 20. The mass of gas exiting the at least one gas inlet 60 is at a pressure in the range of from about 100 psi to about 10 psi. The movement of the liquid electrolyte 20 is in a direction generally parallel to the plane of the surface of the electrode 10 and is at a superficial velocity of at least about 0.1 m/s. The movement of the liquid electrolyte 20 imparts a force to the material on the surface of the electrode 10 thereby causing the material to dislodge from the surface of the electrode 10. In some preferred embodiments, the superficial velocity is from about 0.1 m/s to about 0.2 m/s. In some preferred embodiments, the superficial velocity is about 0.1 m/s.

In some embodiments, the at least one gas inlet 60 is positioned above the surface of the liquid electrolyte 20 to which the mass of gas is applied. In some embodiments, the at least one gas inlet 60 is positioned so that the gas enters the body 30 in a direction that is generally perpendicular to the surface of the liquid electrolyte 20 to which the mass of gas is applied. In some embodiments, the at least one gas inlet 60 is positioned so that the gas enters the body 30 in a direction that is generally parallel to the surface of the liquid electrolyte 20 to which the mass of gas is applied.

Although various embodiments of the invention are disclosed herein, many adaptations and modifications may be made within the scope of the invention in accordance with the common general knowledge of those skilled in this art. Such modifications include the substitution of known equivalents for any aspect of the invention in order to achieve the same result in substantially the same way. Numeric ranges are inclusive of the numbers defining the range. Furthermore, numeric ranges are provided so that the range of values is recited in addition to the individual values within the recited range being specifically recited in the absence of the range. The word “comprising” is used herein as an open-ended term, substantially equivalent to the phrase “including, but not limited to”, and the word “comprises” has a corresponding meaning. As used herein, the singular forms “a”, “an” and “the” include plural references unless the context clearly dictates otherwise. Thus, for example, reference to “a thing” includes more than one such thing. Citation of references herein is not an admission that such references are prior art to the present invention. Furthermore, material appearing in the background section of the specification is not an admission that such material is prior art to the invention. Any priority document(s) are incorporated herein by reference as if each individual priority document were specifically and individually indicated to be incorporated by reference herein and as though fully set forth herein. The invention includes all embodiments and variations substantially as hereinbefore described and with reference to the examples and drawings.

1-44. [canceled]

45. A method for dislodging material from a surface of an electrode, the surface of the electrode being generally covered by a liquid electrolyte, the method comprising: forcing a mass of gas onto a surface of the liquid electrolyte, thereby causing movement of the liquid electrolyte, the movement of the liquid electrolyte being in a direction generally parallel to a plane of the surface of the electrode, the movement of the liquid electrolyte imparting force to the material on the surface of the electrode thereby causing the material to dislodge from the surface of the electrode.

46. The method of claim 45 wherein the movement of the liquid electrolyte is at a superficial velocity of at least about 0.1 m/s from about 0.1 m/s to about 0.2 m/s.

47. The method of claim 45 wherein the mass of gas is distributed evenly over the surface of the liquid electrolyte.

48. The method of claim 45 further comprising forcing a second mass of gas onto the surface of the liquid electrolyte, thereby causing a second movement of the liquid electrolyte, the second movement of the liquid electrolyte being in a direction generally parallel to the plane of the surface of the electrode, the second movement of the liquid electrolyte imparting force to the material on the surface of the electrode thereby causing the material to dislodge from the surface of the electrode, wherein the second movement of the liquid electrolyte has a second superficial velocity of at least about 0.1 m/s, or of about 0.1 m/s.

49. The method of claim 45 wherein the mass of gas is forced onto the surface of the liquid electrolyte by applying pressurized gas to a space immediately adjacent the surface of the liquid electrolyte through at least one gas inlet in a body containing the liquid electrolyte, wherein the mass of gas has an initial pressure of from about 10 psi to about 100 psi prior to being added to the space, or from about 30 psi to about 50 psi prior to being added to the space, or of about 50 psi prior to being added to the space.

50. The method of claim 45 wherein the material was deposited on the electrode by electrochemical deposition, wherein the material is a metal.

51. The method of claim 50 wherein the metal is zinc, the electrode is magnesium, the liquid electrolyte is KOH, and the gas is air.

52. A method for dislodging material from a surface of an electrode, the surface of the electrode generally covered by a liquid electrolyte, the method comprising: forcing a mass of gas through at least one gas inlet of a body containing the liquid electrolyte onto a surface of the liquid electrolyte, thereby causing movement of the liquid electrolyte, the mass of gas exiting the at least one gas inlet at a pressure in the range of from about 100 psi to about 10 psi, the movement of the liquid electrolyte being in a direction generally parallel to a plane of the surface of the electrode and at a superficial velocity of at least about 0.1 m/s, the movement of the liquid electrolyte imparting force to the material on the surface of the electrode thereby causing the material to dislodge from the surface of the electrode.

53. The method of claim 52 wherein the superficial velocity is about 0.1 m/s.

54. The method of claim 52 further comprising forcing a second mass of gas through the at least one gas inlet of the body containing the liquid electrolyte onto the surface of the liquid electrolyte, thereby causing a second movement of the liquid electrolyte, the second mass of gas exiting the at least one gas inlet at a pressure in the range of from about 100 psi to about 10 psi, the second movement of the liquid electrolyte being in a direction generally parallel to the plane of the surface of the electrode and at a second superficial velocity of at least 0.1 m/s or from about 0.1 m/s to about 0.2 m/s, the second movement of the liquid electrolyte imparting force to the material on the surface of the electrode thereby causing the material to dislodge from the surface of the electrode.

55. The method of claim 52 wherein the at least one gas inlet is positioned above the surface of the liquid electrolyte to which the mass of gas is applied.

56. The method of claim 52 wherein the at least one gas inlet is positioned so that the gas enters the body in a direction that is generally perpendicular to the surface of the liquid electrolyte to which the mass of gas is applied.

57. The method of claim 52 wherein the material was deposited on the electrode by electrochemical deposition, wherein the material is a metal.

58. The method of claim 57, wherein the metal is zinc, the electrode is magnesium, the liquid electrolyte is KOH, and the gas is air.

59. An apparatus for dislodging material from a surface of an electrode, the apparatus comprising:
(a) an electrode generally covered by a liquid electrolyte;
(b) a body containing the liquid electrolyte, the body having at least one liquid inlet, at least one liquid outlet, and at least one gas inlet, the at least one gas inlet being positioned such that the at least one gas inlet and the at least one liquid outlet are separated by a volume in which volume a portion of some of the liquid electrolyte is present and some of that portion of liquid electrolyte is at or near the surface of the electrode; and
(c) a pressurized gas source operably connected to the at least one gas inlet;
wherein the liquid electrolyte may enter the body via the at least one liquid inlet and may exit the body via the at least one liquid outlet and a pressurized gas from the pressurized gas source may enter the body via the at least one gas inlet.

60. The apparatus of claim 59 wherein the electrode has a longitudinal plane that is generally parallel to a plane of the surface of the liquid electrolyte when the liquid electrolyte is contained in the body, and wherein the at least one liquid inlet is positioned such that liquid electrolyte from the at least one liquid inlet must pass the longitudinal plane of the electrode to exit the body via the at least one liquid outlet.

61. The apparatus of claim 59 wherein the at least one gas inlet comprises baffles for distributing the pressurized gas as it enters the body, wherein the pressurized gas source has a pressure in the range of from about 10 psi to about 100 psi, or from about 30 psi to about 50 psi, or about 50 psi.

62. The apparatus of claim 59 wherein the pressurized gas is operably linked to the at least one liquid inlet such that as gas enters the body via the at least one gas inlet, thereby forcing some liquid electrolyte to exit the body via the at least one liquid outlet, the at least one liquid inlet is then activated to maintain a generally constant volume of liquid electrolyte in the body.

63. The apparatus of claim 59 wherein said dislodged material may exit the body via the at least one liquid outlet.

64. The apparatus of claim 59 wherein the at least one gas inlet is two gas inlets or one gas inlet, and wherein the at least one liquid inlet is two liquid inlets or one liquid inlet, and wherein the at least one liquid outlet is two liquid outlets or one liquid outlet.
